(19) United States
(12) Patent Application Publication
(10) Pub. No.: US 2020/0245654 A1
(43) Pub. Date: Aug. 6, 2020

(54) Processing and Fresh-Preserving Method For High-Quality Fresh Noodle

(71) Applicant: Jiangnan University, Jiangsu (CN)

(72) Inventors: Kexue Zhu, Wuxi (CN); Xiaona Guo, Wuxi (CN); Donghui Jiang, Wuxi (CN); Junjie Xing, Wuxi (CN); Wei Peng, Wuxi (CN)

(21) Appl. No.: 16/857,345

(22) Filed: Apr. 24, 2020

Related U.S. Application Data
(63) Continuation of application No. PCT/CN2019/078292, filed on Mar. 15, 2019.

(30) Foreign Application Priority Data
Jan. 17, 2019 (CN) 2019100438080

(51) Int. Cl. A23L 7/109

(52) U.S. Cl. CPC A23L 7/109

(57) ABSTRACT

The disclosure discloses a processing and fresh-preserving method for a high-quality fresh noodle, and belongs to the field of flour product processing industry. The processing and fresh-preserving method provided by the disclosure prepares a fresh noodle by using a technology of adding more water, greatly reduces an initial bacterial content in the fresh noodle with the utilization of 33-40% of slightly acidic electrolytic water and in combination with a high-temperature and high-humidity dehydrating technology, guarantees that a product has a good textural property, and can effectively prolong a shelf life of the fresh noodle by preserving at a low temperature of 4-10° C. and make the preservation for 2-3 months at 4-10° C.

### TECHNICAL FIELD

The disclosure belongs to the field of flour product processing industry, and specifically relates to a processing and fresh-preserving method for a high-quality fresh noodle.

### BACKGROUND

Noodles have been a kind of favorite traditional food of Chinese people for over two thousand years, and have become an integral part of the daily diet for most Asian people. For a long time, instant noodles and fine dried noodles are always main forms of noodle products. However, with the improvement of people's living standards and the upgrading of consumption, consumers prefer fresh noodle products with a good mouthfeel. Nevertheless, a series of common problems restrict the rapid development of fresh noodle industry, for example, the mouthfeel is poorer than that of handmade noodles, the shelf life is short, and they are prone to browning and sticking, and so on. In the preparation process of machine-made fresh noodles, the amount of water added often accounts for 28-32%, and in the preparation process of traditional noodles, such as handmade noodles, hand-pulled noodles and sliced noodles, the amount of added water generally accounts for 35-45%. A higher water content may make glutens hydrate fully and form a good gluten network structure, thus forming doughs with good rheological properties and endowing noodle products with good toughness and chewiness as well as a soft and elastic mouthfeel. Machine-made fresh noodle products with a low water content will have an ordinary edible quality, which cannot fully meet pursuits of consumers on fresh noodles with comfortable, smooth, tough, chewy and fully elastic mouthfeels.

On the other hand, fresh noodles are more prone to deterioration, for example, mold growth, turning sour, browning and sticking, during preservation. This is mainly attributed to a high water content, rich nutrient substances, and quickly-bred microbes in fresh noodles, which not only cause noodles to become rancid, but also result in degradation of protein contents, migration of water and serious sticking of noodles; and it is more obvious for fresh noodles with a high initial bacterial content. Additionally, fresh noodles are also prone to discoloration, which is attributed to a high activity of polyphenol oxidase in fresh noodles, accelerating the enzymatic browning rate, rapidly darkening the color of fresh noodles and reducing the sensory quality of fresh noodles.

For the quality improvement of fresh noodles, currently most of enterprises realize it through adding some additives, which could help them achieve their purposes to some extents, but it is opposite to the philosophy of consumers to pursue green and health diets. For the problem of the short shelf life of fresh noodles during preservation, currently there are many solutions reported, for example, adding alcohol, adding acid or alkaline, etc. Although these methods are effective, they result in some bad smells, which affects the acceptability of consumers. Therefore, it is a future development trend to use advanced technologies and devices, starting from raw and auxiliary materials of the production source and the whole production and processing process, to implement quality improvement and fresh preservation of fresh noodles.

### SUMMARY

In view of a problem that fresh noodle is easily deteriorated, the disclosure reduces influences of microbes and polyphenol oxidase on quality deterioration of the fresh noodle during preservation from raw material, and uses slightly acidic electrolytic water for dough kneading. The slightly acidic electrolytic water is an aqueous solution with a pH of 5.0-6.5 and obtained by taking diluted hydrochloric acid (diluted hydrochloric acid with a mass fraction of lower than 20%) as an electrolyte and electrolyzing the electrolyte with a diaphragm-free electrolytic bath. It is colorless, odorless, smell-less, and low in cost, and is restored to common water in a heating or sterilizing process. It is safe, residue-free, and non-irritant and harmless to human body, and has no pollution to environment in discharge. Meanwhile, the slightly acidic electrolytic water has a strong sterilizing effect to various microbes and has the characteristics of instantaneousness, broad spectrum, effectiveness and no pollution. There hasn't been a report on use of the slightly acidic electrolytic water in fresh preservation of the noodles. Heat treatment is a common sterilization method during processing of the noodles, and also a sterilization technology widely used in industry at present. However, during the processing of the fresh noodles, a technology of adding more water makes a water content of the noodles at 35-40%. The disclosure attempts to use a high-temperature and high-humidity method to reduce water and bacteria in the fresh noodle, so that the final water content of the fresh noodle product is reduced to 28-30% at last to solve problems that the fresh noodle is sticky easily and is spread with too much flour on one hand, and on the other hand, the content of bacteria in the fresh noodle product is also reduced to prolong a shelf life.

A first objective of the disclosure is to provide a fresh noodle; and a formula of the fresh noodle includes 90-100 parts of wheat flour, 33-40 parts of slightly acidic electrolytic water, 0.5-1 parts of monosodium fumarate, 0.04-0.24 parts of sodium lactate, 0.10-0.15 parts of propanediol, 0.10-0.15 parts of sorbitol solution, and 0.40-2.40 parts of composite phosphate by weight, an amount of the added slightly acidic electrolytic water being 33-40% of the wheat flour by weight.

In an embodiment of the disclosure, the formula of the fresh noodle includes 90-100 parts of wheat flour, 34-40 parts of slightly acidic electrolytic water, 0.5-1 parts of monosodium fumarate, 0.16-0.24 parts of sodium lactate, 0.10-0.15 parts of propanediol, 0.10-0.15 parts of sorbitol solution, and 1.6-2.40 parts of composite phosphate by weight, an amount of the added slightly acidic electrolytic water being 34-40% of the wheat flour by weight.

In an embodiment of the disclosure, the slightly acidic electrolytic water has a pH of 5.0-6.5.

In an embodiment of the disclosure, an effective chlorine concentration of the slightly acidic electrolytic water is 10-70 ppm.

In an embodiment of the disclosure, an effective chlorine concentration of the slightly acidic electrolytic water is 50-70 ppm.

In an embodiment of the disclosure, the formula further includes 0.5-1.5 parts of edible salt by weight.

In an embodiment of the disclosure, the composite phosphate includes two or more of sodium pyrophosphate, sodium tripolyphosphate and sodium hexametaphosphate.

In an embodiment of the disclosure, the composite phosphate is a mixture of the sodium pyrophosphate, the sodium tripolyphosphate and the sodium hexametaphosphate; and a mass ratio of the sodium pyrophosphate to the sodium tripolyphosphate to the sodium hexametaphosphate is (0.3-0.8):1:(1-1.5), preferably 27:45:48.

In an embodiment of the disclosure, the wheat flour has an ash content of smaller than 0.5%, a total bacterial count of not greater than 1*10⁴ log CFU/g, and a damaged starch content of smaller than 8%.

A second objective of the disclosure is to provide a processing technology for a fresh noodle, including the following steps:

(1) dough mixing: mixing 90-100 parts of wheat flour, 33-40 parts of slightly acidic electrolytic water, 0.5-1 parts of monosodium fumarate, 0.5-1.5 parts of edible salt, 0.04-0.24 parts of sodium lactate, 0.10-0.15 parts of propanediol, 0.10-0.15 parts of sorbitol solution, and 0.40-2.40 parts of composite phosphate by weight for dough mixing to obtain a crumbly dough;

(2) resting the crumbly dough obtained in the step (1), and sheeting step by step to obtain a noodle sheet;

(3) resting the noodle sheet obtained in the step (2), sheeting reversely and then cutting to obtain a noodle; and

(4) dehydrating and forming: dehydrating the noodle obtained in the step (3) to obtain the fresh noodle.

In an embodiment of the disclosure, a temperature during the dehydrating in the step (4) is 60-100° C.

The temperature is preferably 80-100° C.

In an embodiment of the disclosure, a humidity during the dehydrating in the step (4) is 50-90%.

The humidity is preferably 70-90%.

In an embodiment of the disclosure, a dehydrating manner in the step (4) is performed in an environment having a certain humidity, including electric heating dehydration, steam heating dehydration and infrared dehydration.

In an embodiment of the disclosure, the sheeting reversely in the step (3) refers to that the rested noodle sheet is folded and sheeted for multiple times at 30-45° to implement 90°-rotation reverse sheeting of the noodle sheet at last, and then the noodle strap is sheeted step by step by a sheeting roll to a required thickness.

In an embodiment of the disclosure, the noodle sheet is rested for 20-40 min under a condition where a temperature is 20-30° C. and a humidity is 60-80% in the step (3).

In an embodiment of the disclosure, the crumbly dough in the step (2) is rested on an airtight conveyor belt, and an ultraviolet lamp is disposed on an inner upper side of the conveyor belt for irradiation.

In an embodiment of the disclosure, the dough mixing in the step (1) is performed in a vacuum mixer, where a vacuum degree is −0.05MPa to −0.08 MPa, dough mixing time is 5-15 min, and a dough mixing temperature is controlled at 15-25° C.

In an embodiment of the disclosure, the technology further includes a moisture equilibrium process after the dehydrating, and the moisture equilibrium method includes:

tempering the dehydrated noodle for 2-3 h in an airtight tempering chamber, a temperature in the tempering chamber being 4-10° C., and the tempering chamber being sterilized by 75% atomized alcohol in advance, or irradiated by the ultraviolet lamp for 2-4 h, to guarantee the sterility.

In an embodiment of the disclosure, the technology may further include packaging and preserving.

In an embodiment of the disclosure, the packaging method includes: packaging the noodle with the adoption of a high barrier packaging material and in combination with a deoxidant, the packaging material being a composite packaging material having low oxygen transmissibility and moisture permeability or an aluminum foil.

In an embodiment of the disclosure, the preserving is to preserve under a condition of 4-10° C.

A third objective of the disclosure is to provide a fresh-preserving method for a fresh noodle, including the above-mentioned processing technology.

The disclosure has the following beneficial effects:

The disclosure prepares a fresh noodle with a repeated water adding, greatly improving a mouthfeel of the fresh noodle. Compared with the addition of an additive, the disclosure is simple, convenient, and high in efficiency, and in line with a development concept of fresh noodle for environmental protection and health. By means of improving an amount of added water in the fresh noodle appropriately, water absorption of a protein and a starch is increased, which is helpful for formation of a network structure of the protein. Therefore, the quality of the fresh noodle is improved. Additionally, by reversely sheeting, a noodle sheet is sheeted fully from different angles to better promote an interaction between the protein and the starch in the noodle sheet, thus forming a better network structure of gluten and endowing the noodle with a more excellent mouthfeel. The technology of the disclosure, that is an optimized technology in combination with repeated water adding, vacuum mixing, crumbly dough resting, step-by-step sheeting, noodle sheet resting, and reverse folding and sheeting, may be an attempt to solve a problem that the fresh noodle is poorer than a pappardelle noodle in mouthfeel, and prepares a high-quality fresh noodle in line with the environment-friendly and healthy development concept to meet a pursuit of people on the fresh noodle in terms of tough and chewy, smooth and comfortable, and elastic mouthfeel.

The technology of the disclosure prepares a high-quality fresh noodle and improves sensory quality and edible quality of the fresh noodle. Meanwhile, a fresh-preserving method provided by the disclosure treats raw and auxiliary materials of the fresh noodle from a whole process in noodle production, and uses slightly acidic electrolytic water to mix a dough, thus greatly reducing an initial bacterial count of the fresh noodle; and during preparation, the fresh-preserving method controls a processing process to be free from microbial pollution, and uses the repeated water adding technology and a high-temperature and high-humidity dehydrating technology to further reduce bacteria; and the prepared noodle inhibits the bacteria during preservation in a packaging method in which a high barrier packaging material is used and a deoxidant is added, and is preserved under a condition of a low temperature (4-10° C.). The method effectively prolongs a shelf life of the fresh noodle, and makes the preservation for 2-3 months at 4-10° C.

With the adoption of the repeated water adding technology and the high-temperature and high-humidity dehydrating technology, the disclosure guarantees that the final fresh noodle has a water content of 28-30% and a low degree of gelatinization, and further kills a microbe in the fresh noodle while in a state of the fresh noodle; and furthermore, the disclosure may solve browning and sticking problems of the fresh noodle.

### BRIEF DESCRIPTION OF FIGURES

FIG. 1 illustrates an influence of slightly acidic electrolytic water at different concentrations on an initial bacterial count of a fresh noodle.

FIG. 2 illustrates an influence of different dehydrating conditions on an initial bacterial count of a fresh noodle.

FIG. 3 illustrates an influence of different dehydrating conditions on an initial bacterial count of a fresh noodle.

### DETAILED DESCRIPTION

The technical solutions of the disclosure are further described below in detail by means of a plurality of embodiments. However, the selected embodiments are merely used for illustrating the disclosure rather than limiting the scope of the disclosure.

Texture determination indicator: including a texture profile parameter and a tensile parameter, to embody such characteristics as hardness, elasticity and chewiness.

A following manner is used to perform texture profile test and analysis on the noodle, including: a reheated noodle (20 cm/piece) was paved in a preservative film, and two noodles were taken randomly at each time for the texture profile test and analysis. The texture analyzer in use is a texture analyzer produced by Stable Micro System in British, the probe is HDP/PFS, the velocity before, during and after the test is 0.8 mm/s, the interval time is 1 s, the compression is performed twice, and each batch of samples are tested for 10 times in parallel.

A following manner is used to perform tensile test and analysis on the noodle, including: a reheated noodle (20 cm/piece) was paved in a preservative film, and one noodle was taken randomly at each time for the tensile test and analysis. The texture analyzer in use is a texture analyzer produced by SMS in British, the probe is A/SPR, the velocity before, during and after the test is respectively 2 mm/s, 2 mm/s and 10 mm/s, and each batch of samples are tested for 10 times in parallel.

Determination on shelf life: a noodle was placed under a condition in which a temperature was 10° C. and a humidity was 30%, and an indicator of the noodle was detected every fixed time till the noodle was deteriorated.

### EXAMPLE 1

Formula: 100 kg of wheat flour, 1.5 kg of edible salt, 0.24 g of sodium lactate, 1 kg of monosodium fumarate, 0.15 kg of propanediol, 3 kg of sorbitol solution, 2.4 g of composite phosphate, and 40 kg of slightly acidic electrolytic water.

Technology:

(1) Vacuum mixing: 100 kg of wheat flour was added to a vacuum mixer; 27 kg of 70 ppm slightly acidic electrolytic water was added to a stirring mixer, a stirring device was started, 1 kg of monosodium fumarate, 0.24 g of sodium lactate, 0.15 kg of propanediol, 3 kg of sorbitol solution, 2.4 g of composite phosphate, and 1.5 kg of edible salt that were weighed as required by the formula were then added sequentially and slowly, 13 kg of rest 70 ppm slightly acidic electrolytic water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Reverse folding and sheeting: the rested noodle sheet was folded and sheeted twice at 45° to implement 90°-rotation reverse sheeting of the noodle sheet at last, and then the noodle sheet was sheeted step by step by a sheeting roll to a required thickness.

(6) Cutting: the sheeted noodle sheet was cut into a noodle on a noodle maker.

(7) Dehydrating, tempering and forming: the obtained noodle was dehydrated and tempered sequentially, a dehydrating method including: the noodle was dehydrated in a drying oven, a dehydrating manner being electric heating dehydration, a dehydrating temperature being 100° C., a humidity being 90% and a final water content being controlled at 28%; and a tempering method including: the dehydrated noodle was tempered for 2 h in an airtight tempering chamber, the tempering chamber having a temperature of 4° C.; and the tempering chamber being sterilized by 75% atomized alcohol in advance to guarantee the sterility.

(8) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(9) Preservation: the packaged fresh noodle was preserved at 10° C.

### EXAMPLE 2

Formula: 100 kg of wheat flour, 1.5 kg of edible salt, 0.8 kg of monosodium fumarate, 0.04 g of sodium lactate, 0.15 kg of propanediol, 3 kg of sorbitol solution, 0.4 g of composite phosphate, and 33 kg of slightly acidic electrolytic water.

Technology:

(1) Vacuum mixing: 100 kg of wheat flour was added to a vacuum mixer; 22 kg of 70 ppm slightly acidic electrolytic water that was required was added to a stirring mixer, a stirring device was started, 0.8 kg of monosodium fumarate, 0.04 g of sodium lactate, 0.15 kg of propanediol, 3 kg of sorbitol solution, 2.4 g of composite phosphate, and 1.5 kg of edible salt that were weighed as required by the formula were then added sequentially and slowly, 11 kg of rest 70 ppm slightly acidic electrolytic water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Reverse folding and sheeting: the rested noodle sheet was folded and sheeted twice at 45° to implement 90°-rotation reverse sheeting of the noodle sheet at last, and then the noodle sheet was sheeted step by step by a sheeting roll to a required thickness.

(6) Cutting: the sheeted noodle sheet was cut into a noodle on a noodle maker.

(7) Dehydrating, tempering and forming: the obtained noodle was dehydrated and tempered sequentially, a dehydrating method including: the noodle was dehydrated in a drying oven, a dehydrating manner being electric heating dehydration, a dehydrating temperature being 100° C., a humidity being 90% and a final water content being controlled at 28%; and a tempering method including: the dehydrated noodle was tempered for 2 h in an airtight tempering chamber, the tempering chamber having a temperature of 4° C.; and the tempering chamber being sterilized by 75% atomized alcohol in advance to guarantee the sterility.

(8) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(9) Preservation: the packaged fresh noodle was preserved at 10° C.

### EXAMPLE 3

Formula: 100 kg of wheat flour, 0.5 kg of edible salt, 0.5 kg of monosodium fumarate, 0.12 g of sodium lactate, 0.05 kg of propanediol, 1.5 kg of sorbitol solution, 1.2 g of composite phosphate, and 38 kg of slightly acidic electrolytic water.

Technology:

(1) Vacuum mixing: 100 kg of wheat flour was added to a vacuum mixer; 26 kg of 70 ppm slightly acidic electrolytic water was added to a stirring mixer, a stirring device was started, 0.5 kg of monosodium fumarate, 0.12 g of sodium lactate, 0.05 kg of propanediol, 1.5 kg of sorbitol solution, 1.2 g of composite phosphate, and 0.5 kg of edible salt that were weighed as required by the formula were then added sequentially and slowly, 12 kg of rest 70 ppm slightly acidic electrolytic water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Reverse folding and sheeting: the rested noodle sheet was folded and sheeted twice at 45° to implement 90°-rotation reverse sheeting of the noodle sheet at last, and then the noodle sheet was sheeted step by step by a sheeting roll to a required thickness.

(6) Cutting: the sheeted noodle sheet was cut into a noodle on a noodle maker.

(7) Dehydrating, tempering and forming: the obtained noodle was dehydrated and tempered sequentially, a dehydrating method including: the noodle was dehydrated in a drying oven, a dehydrating manner being electric heating dehydration, a dehydrating temperature being 100° C., a humidity being 90% and a final water content being controlled at 28%; and a tempering method including: the dehydrated noodle was tempered for 2 h in an airtight tempering chamber, the tempering chamber having a temperature of 4° C.; and the tempering chamber being sterilized by 75% atomized alcohol in advance to guarantee the sterility.

(8) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(9) Preservation: the packaged fresh noodle was preserved at 10° C.

The performance test is performed on the fresh noodle obtained in Embodiments 1-3, with a result shown in table 1.

TABLE 1
Quality of fresh noodle obtained in examples 1-3

| | | | | Total | |
|---|---|---|---|---|---|
| | Texture property | | | bacterial | |
| | Hardness | Elas- | Chewi- | count | Shelf life |
| Example | (g) | ticity | ness | (I gCFU/g) | (days) |
| 1 | 2871 | 0.926 | 1632 | 1 | 90 |
| 2 | 2530 | 0.865 | 1543 | 1.56 | 60 |
| 3 | 2706 | 0.882 | 1596 | 1.15 | 80 |

### EXAMPLE 4

### Technology Optimization

1) Influence of Slightly Acidic Electrolytic Water at Different Concentrations on Quality of Fresh Noodle:

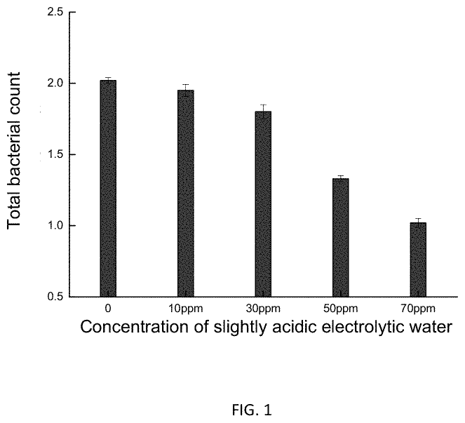

Referring to the technology and the formula in example 1, the slightly acidic electrolytic water having an effective chlorine concentration of 0 ppm, 10 ppm, 30 ppm, 50 ppm and 70 ppm is respectively used to prepare the fresh noodle, with the initial bacterial count in the fresh noodle as shown in FIG. 1. Under a dehydrating condition at 100° C. and 90% of humidity, as the concentration of the slightly acidic electrolytic water is increased, the initial bacterial count in the fresh noodle trends to decline, which indicates that the slightly acidic electrolytic water used for dough mixing has an antibacterial effect indeed. However, as the concentration of the slightly acidic electrolytic water is smaller than 30 ppm, the antibacterial effect is not ideal, and the initial bacterial count is decreased from 2.02 IgCFU/g to 1.8 IgCFU/g, a decrease of merely 0.22 IgCFU/g. As the concentration of the slightly acidic electrolytic water is at preferable 50-70 ppm, the antibacterial effect is obvious, and the initial bacterial count in the fresh noodle is decreased by (0.69-1) IgCFU/g.

Meanwhile, as can be seen from table 2, after the slightly acidic electrolytic water is added to the formula of the disclosure, the texture quality of the fresh noodle is not damaged, and the texture property is good.

TABLE 2
Texture quality of fresh noodle obtained by slightly
acidic electrolytic water at different concentrations

| Concentration of | | | |
|---|---|---|---|
| slightly acidic | Texture property | | |
| electrolytic | Hardness | Elas- | Chewi- |
| water ppm | (g) | ticity | ness |
| 0 | 2730 | 0.874 | 1552 |
| 10 | 2750 | 0.884 | 1567 |
| 30 | 2785 | 0.892 | 1583 |
| 50 | 2842 | 0.906 | 1604 |
| 70 | 2871 | 0.926 | 1632 |

2) Influence of Different Dehydrating Conditions on Initial Bacterial Count of Fresh Noodle

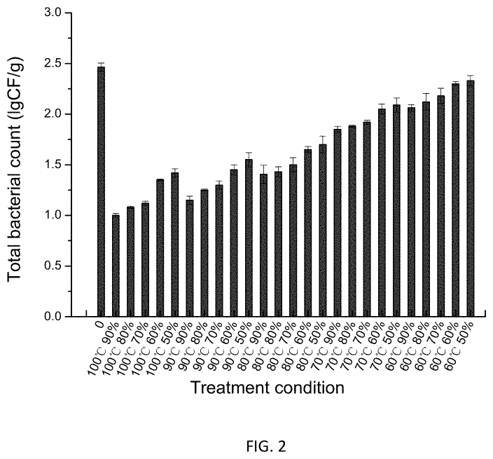

Referring to the technology and the formula in example 1, dehydrating conditions at 60-100° C. and 70-90% of humidity are tested respectively, with a result as shown in FIG. 2. Preferably, on the basis of 70 ppm slightly acidic electrolytic water, the temperature is not lower than 80° C. and the humidity is not lower than 70%. Under a condition with the preferable temperature and humidity, the initial bacterial count may be decreased from 2.46 IgCFU/g to (1.50-1) IgCFU/g, a decrease of (0.96-1.43) of log value. However, as the temperature is lower than 80° C. and the humidity is lower than 70%, the initial bacterial count can only be decreased by 0.41 IgCFU/g at most.

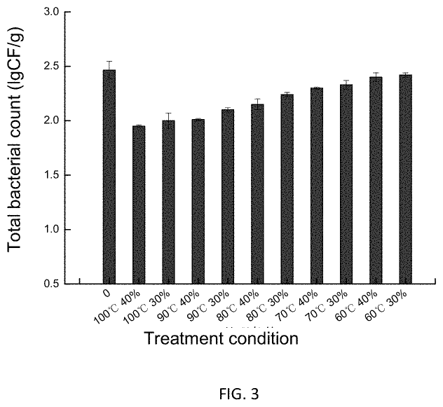

Additionally, if the dehydrating condition in example 1 is replaced as a low-humidity baking oven, that is, 30-40% of humidity, the effect of the prepared fresh noodle is as shown in FIG. 3. In the low-humidity baking oven, as the temperature is 100° C. and the humidity is 40%, the initial bacterial count is decreased most from 2.46 IgCFU/g to 1.95 IgCFU/g, a decrease of only 0.51 IgCFU/g, which is equivalent to a sterilization effect of high-humidity dehydrating treatment in which a temperature is 70° C. and a humidity is 70%; and as the temperature is lower than 80° C., the initial bacterial count is only decreased by 0.16 IgCFU/g at most, and the sterilization effect is obviously lower than the high-humidity dehydrating treatment.

### COMPARATIVE EXAMPLE 1

Formula: 100 kg of wheat flour, 1 kg of edible salt, and 32 kg of water.

Technology:

(1) Vacuum mixing 100 kg of wheat flour was added to a vacuum mixer; 22 kg of water that was required was added to a stirring mixer, a stirring device was started, 1 kg of edible salt that were weighed as required by the formula were then added sequentially and slowly, 10 kg of rest water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Reverse folding and sheeting: the rested noodle sheet was folded and sheeted twice at 45° to implement 90°-rotation reverse sheeting of the noodle sheet at last, and then the noodle sheet was sheeted step by step by a sheeting roll to a required thickness.

(6) Cutting: the sheeted noodle sheet was cut into a noodle on a noodle maker.

(7) Dehydrating, tempering and forming: the obtained noodle was dehydrated and tempered sequentially, a dehydrating method including: the noodle was dehydrated in a drying oven, a dehydrating manner being electric heating dehydration, a dehydrating temperature being 100° C., a humidity being 90% and a final water content being controlled at 28%; and a tempering method including: the dehydrated noodle was tempered for 2 h in an airtight tempering chamber, the tempering chamber having a temperature of 4° C.; and the tempering chamber being sterilized by 75% atomized alcohol in advance to guarantee the sterility.

(8) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(9) Preservation: the packaged fresh noodle was preserved at 10° C.

### COMPARATIVE EXAMPLE 2

Referring to Embodiment 1, the formula includes: 100 kg of wheat flour, 1.5 kg of edible salt, 0.24 g of sodium lactate, 1 kg of monosodium fumarate, 0.15 kg of propanediol, 3 kg of sorbitol solution, 2.4 g of composite phosphate, and 40 kg of slightly acidic electrolytic water.

Technology:

The reverse folding and sheeting procedure in the step (5) is omitted in the technology.

(1) Vacuum mixing: 100 kg of wheat flour was added to a vacuum mixer; 27 kg of 70 ppm slightly acidic electrolytic water was added to a stirring mixer, a stirring device was started, 1 kg of monosodium fumarate, 0.24 g of sodium lactate, 0.15 kg of propanediol, 3 kg of sorbitol solution, 2.4 g of composite phosphate, and 1.5 kg of edible salt that were weighed as required by the formula were then added sequentially and slowly, 13 kg of rest 70 ppm slightly acidic electrolytic water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Cutting: the rested noodle sheet was cut into a noodle on a noodle maker.

(6) Dehydrating, tempering and forming: the obtained noodle was dehydrated and tempered sequentially, a dehydrating method including: the noodle was dehydrated in a drying oven, a dehydrating manner being electric heating dehydration, a dehydrating temperature being 100° C., a humidity being 90% and a final water content being controlled at 28%; and a tempering method including: the dehydrated noodle was tempered for 2 h in an airtight tempering chamber, the tempering chamber having a temperature of 4° C.; and the tempering chamber being sterilized by 75% atomized alcohol in advance to guarantee the sterility.

(7) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(8) Preservation: the packaged fresh noodle was preserved at 10° C.

### COMPARATIVE EXAMPLE 3

Formula: 100 kg of wheat flour, 1.5 kg of edible salt, 0.24 kg of sodium lactate, 1 kg of monosodium fumarate, 0.15 kg of propanediol, 3 kg of sorbitol solution, 2.4 g of composite phosphate, and 30 kg of slightly acidic electrolytic water.

Technology:

(1) Vacuum mixing: 100 kg of wheat flour was added to a vacuum mixer; 20 kg of 70 ppm slightly acidic electrolytic water was added to a stirring mixer, a stirring device was started, 1 kg of monosodium fumarate, 0.24 g of sodium lactate, 0.15 kg of propanediol, 3 kg of sorbitol solution, 2.4 g of composite phosphate, and 1.5 kg of edible salt that were weighed as required by the formula were then added sequentially and slowly, 10 kg of rest 70 ppm slightly acidic electrolytic water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Reverse folding and sheeting: the rested noodle sheet was folded and sheeted twice at 45° to implement 90°-rotation reverse sheeting of the noodle sheet at last, and then the noodle sheet was sheeted step by step by a sheeting roll to a required thickness.

(6) Cutting: the sheeted noodle sheet was cut into a noodle on a noodle maker.

(7) Dehydrating, tempering and forming: the obtained noodle was dehydrated and tempered sequentially, a dehydrating method including: the noodle was dehydrated in a drying oven, a dehydrating manner being electric heating dehydration, a dehydrating temperature being 100° C., a humidity being 90% and a final water content being controlled at 28%; and a tempering method including: the dehydrated noodle was tempered for 2 h in an airtight tempering chamber, the tempering chamber having a temperature of 4° C.; and the tempering chamber being sterilized by 75% atomized alcohol in advance to guarantee the sterility.

(8) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(9) Preservation: the packaged fresh noodle was preserved at 10° C.

### COMPARATIVE EXAMPLE 4

Formula: 100 kg of wheat flour, 1.5 kg of edible salt, 0.24 kg of sodium lactate, 1 kg of monosodium fumarate, 0.15 kg of propanediol, 3 kg of sorbitol solution, 2.4 g of composite phosphate, and 40 kg of sterile water.

Technology:

(1) Vacuum mixing: 100 kg of wheat flour was added to a vacuum mixer; 27 kg of sterile water that was required was added to a stirring mixer, a stirring device was started, 1 kg of monosodium fumarate, 0.24 g of sodium lactate, 0.15 kg of propanediol, 3 kg of sorbitol solution, 2.4 g of composite phosphate, and 1.5 kg of edible salt that were weighed as required by the formula were then added sequentially and slowly, 13 kg of rest sterile water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Reverse folding and sheeting: the rested noodle sheet was folded and sheeted twice at 45° to implement 90°-rotation reverse sheeting of the noodle sheet at last, and then the noodle sheet was sheeted step by step by a sheeting roll to a required thickness.

(6) Cutting: the sheeted noodle sheet was cut into a noodle on a noodle maker.

(7) Dehydrating, tempering and forming: the obtained noodle was dehydrated and tempered sequentially, a dehydrating method including: the noodle was dehydrated in a drying oven, a dehydrating manner being electric heating dehydration, a dehydrating temperature being 100° C., a humidity being 90% and a final water content being controlled at 28%; and a tempering method including: the dehydrated noodle was tempered for 2 h in an airtight tempering chamber, the tempering chamber having a temperature of 4° C.; and the tempering chamber being sterilized by 75% atomized alcohol in advance to guarantee the sterility.

(8) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(9) Preservation: the packaged fresh noodle was preserved at 10° C.

### COMPARATIVE EXAMPLE 5

Referring to Embodiment 1, the formula includes: 100 kg of wheat flour, 1.5 kg of edible salt, 0.24 g of sodium lactate, 1 kg of monosodium fumarate, 0.15 kg of propanediol, 3 kg of sorbitol solution, 2.4 g of composite phosphate, and 40 kg of slightly acidic electrolytic water.

Technology:

(1) Vacuum mixing: 100 kg of wheat flour was added to a vacuum mixer; 27 kg of 70 ppm slightly acidic electrolytic water was added to a stirring mixer, a stirring device was started, 1 kg of monosodium fumarate, 0.24 g of sodium lactate, 0.15 kg of propanediol, 3 kg of sorbitol solution, 2.4 g of composite phosphate, and 1.5 kg of edible salt that were weighed as required by the formula were then added sequentially and slowly, 13 kg of rest 70 ppm slightly acidic electrolytic water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Reverse folding and sheeting: the rested noodle sheet was folded and sheeted twice at 45° to implement 90°-rotation reverse sheeting of the noodle sheet at last, and then the noodle sheet was sheeted step by step by a sheeting roll to a required thickness.

(6) Cutting: the sheeted noodle sheet was cut into a noodle on a noodle maker.

(7) Tempering and forming: the obtained noodle was tempered for 2 h in an airtight tempering chamber, the tempering chamber having a temperature of 4° C.; and the tempering chamber being sterilized by 75% atomized alcohol in advance to guarantee the sterility.

(8) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(9) Preservation: the packaged fresh noodle was preserved at 10° C.

### COMPARATIVE EXAMPLE 6

Formula: 100 kg of wheat flour, 1.5 kg of edible salt, 0.24 kg of sodium lactate, 1 kg of monosodium fumarate, 0.15 kg of propanediol, 3 kg of sorbitol solution, 2.4 g of composite phosphate, and 40 kg of slightly acidic electrolytic water.

Technology:

(1) Vacuum mixing: 100 kg of wheat flour was added to a vacuum mixer; 27 kg of 70 ppm slightly acidic electrolytic water was added to a stirring mixer, a stirring device was started, 1 kg of monosodium fumarate, 0.24 g of sodium lactate, 0.15 kg of propanediol, 3 kg of sorbitol solution, 2.4 g of composite phosphate, and 1.5 kg of edible salt that were weighed as required by the formula were then added sequentially and slowly, 13 kg of rest 70 ppm slightly acidic electrolytic water was then added, and the above ingredients were stirred uniformly and then pumped into the vacuum mixer; and the vacuum mixer was started to mix a dough for 5 min at 15° C. under a condition in which a vacuum degree was −0.08 Mpa to obtain a crumbly dough.

(2) Crumbly dough resting: the crumbly dough was conveyed slowly on a conveyor belt, and stood on an airtight conveyor belt for resting, an ultraviolet lamp being installed on an inner upper side of the conveyor belt for irradiation and sterilization.

(3) Step-by-step sheeting: the obtained rested crumbly dough was pressed into a noodle sheet, and sheeted step by step to prepare into a continuous smooth noodle sheet.

(4) Noodle sheet resting: the noodle sheet was placed into an resting box in a condition, in which a temperature was 20° C. and a humidity was 60%, to rest for 20 min, an ultraviolet sterilization device being installed in the resting box to prevent microbial pollution in an resting process and kill a microbe on a surface of the noodle sheet by the use of the resting time.

(5) Reverse folding and sheeting: the rested noodle sheet was folded and sheeted twice at 45° to implement 90°-rotation reverse sheeting of the noodle sheet at last, and then the noodle sheet was sheeted step by step by a sheeting roll to a required thickness.

(6) Cutting: the sheeted noodle sheet was cut into a noodle on a noodle maker.

(7) Dehydrating, tempering and forming: the obtained noodle was dehydrated and tempered sequentially, a dehydrating method including: the noodle was dehydrated in a drying oven, a dehydrating manner being electric heating dehydration, a dehydrating temperature being 100° C., a humidity being 40% and a final water content being controlled at 28%; and a tempering method including: the dehydrated noodle was tempered for 2 h in an airtight tempering chamber, the tempering chamber having a temperature of 4° C.; and the tempering chamber being sterilized by 75% atomized alcohol in advance to guarantee the sterility.

(8) Packaging: the tempered noodle was weighed, and packaged with the adoption of a high barrier packaging material and in combination with a deoxidant, the packaging material being a composite packaging material having low oxygen transmissibility and moisture permeability or an aluminum foil.

(9) Preservation: the packaged fresh noodle was preserved at 10° C.

The performance test is performed on a product obtained in Example s 1-6, with a result shown in table 2.

TABLE 3
Quality of fresh noodle obtained in Comparative Example s 1-6

| | | | | Total | |
|---|---|---|---|---|---|
| | Texture property | | | bacterial | |
| Comparative | Hardness | Elas- | Chewi- | count | Shelf life |
| embodiment | (g) | ticity | ness | (IgCFU/g) | (days) |
| 1 | 2400 | 0.850 | 1459 | 3.64 | 12 |
| 2 | 2465 | 0.855 | 1502 | 1 | 90 |
| 3 | 2500 | 0.862 | 1522 | 2.95 | 18 |
| 4 | 2730 | 0.874 | 1552 | 2 | 45 |
| 5 | 2765 | 0.878 | 1582 | 2.50 | 30 |
| 6 | 2720 | 0.875 | 1578 | 1.97 | 40 |

As can be seen from the above embodiments and comparative embodiments, the disclosure applies slightly acidic electrolytic water to fresh preservation of a noodle, and uses the slightly acidic electrolytic water for dough mixing. The slightly acidic electrolytic water is an aqueous solution having a pH of 5-6.5 and obtained by taking diluted hydrochloric acid as an electrolyte and electrolyzing the electrolyte with a diaphragm-free electrolytic bath. It is colorless, odorless, smell-less, and low in cost, and is restored to common water in a heating or sterilizing process. Moreover, it is safe, residue-free, and non-irritant and harmless to a human body, and has no pollution to an environment in discharge.

The disclosure prepares the high-quality fresh noodle with frequent water adding and optimizing production technologies, improves sensory quality and edible quality of the fresh noodle, and provides a fresh-preserving method. The disclosure first treats raw and auxiliary materials of the fresh noodle from a whole process in noodle production, and uses preferred wheat flour and slightly acidic electrolytic water for dough mixing, to reduce an initial bacterial count of the fresh noodle; and controls a processing process to be free from microbial pollution with a method such as ultraviolet lamp sterilization, and further uses the frequent water adding technology and a high-temperature and high-humidity dehydrating technology to further reduce bacteria. The prepared noodle inhibits the bacteria during preservation in a packaging manner in which a high barrier packaging material is used and a deoxidant is added, and is preserved under a condition of a low temperature (4-10° C.).

What is claimed is:

1. A fresh noodle, comprising the following ingredients in parts by weight: 90-100 parts of wheat flour, 33-40 parts of slightly acidic electrolytic water, 0.5-1 parts of monosodium fumarate, 0.04-0.24 parts of sodium lactate, 0.10-0.15 parts of propanediol, 0.10-0.15 parts of sorbitol solution, and 0.40-2.40 parts of composite phosphate, wherein an added amount of the slightly acidic electrolytic water is 33-40% of the wheat flour by weight.

2. The fresh noodle according to claim 1, wherein the slightly acidic electrolytic water is obtained by taking a diluted hydrochloric acid as an electrolyte for electrolysis, and the slightly acidic electrolytic water has a pH value of 5.0-6.5.

3. The fresh noodle according to claim 1, wherein an effective chlorine concentration of the slightly acidic electrolytic water is 10-70 ppm.

4. The fresh noodle according to claim 1, wherein an effective chlorine concentration of the slightly acidic electrolytic water is 50-70 ppm.

5. The fresh noodle according to claim 1, further comprising 0.5-1.5 parts of edible salt by weight.

6. The fresh noodle according to claim 1, wherein the composite phosphate comprises two or more selected from a group consisting of sodium pyrophosphate, sodium tripolyphosphate and sodium hexametaphosphate.

7. A method for processing a fresh noodle, comprising the following steps:
(1) dough mixing: mixing 90-100 parts of wheat flour, 33-40 parts of slightly acidic electrolytic water, 0.5-1 parts of monosodium fumarate, 0.5-1.5 parts of edible salt, 0.04-0.24 parts of sodium lactate, 0.10-0.15 parts of propanediol, 0.10-0.15 parts of sorbitol solution, and 0.40-2.40 parts of composite phosphate for dough mixing to obtain a crumbly dough;
(2) resting the crumbly dough obtained in the step (1), and sheeting step by step to prepare into a noodle sheet;
(3) resting the noodle sheet obtained in the step (2), sheeting reversely and then cutting to obtain a noodle; and
(4) dehydrating and forming dehydrating the noodle obtained in the step (3) to obtain the fresh noodle.

8. The method according to claim 7, wherein a dehydrating temperature is 60-100° C., and a dehydrating humidity is 50-90% in the step (4).

9. The method according to claim 7, wherein an effective chlorine concentration of the slightly acidic electrolytic water in the step (1) is 50-70 ppm.

10. The method according to claim 7, wherein the dough in the step (1) further comprises 0.5-1.5 parts of edible salt by weight.

11. The method according to claim 7, wherein the composite phosphate in the step (1) comprises two or more selected from a group consisting of sodium pyrophosphate, sodium tripolyphosphate and sodium hexametaphosphate.

12. The method according to claim 7, comprising the following steps:
(1) dough mixing: mixing 90-100 parts of wheat flour, 33-40 parts of slightly acidic electrolytic water, 0.5-1 parts of monosodium fumarate, 0.5-1.5 parts of edible salt, 0.04-0.24 parts of sodium lactate, 0.10-0.15 parts of propanediol, 0.10-0.15 parts of sorbitol solution, and 0.40-2.40 parts of composite phosphate for dough mixing to obtain a crumbly dough, an added amount of the slightly acidic electrolytic water being 33-40% of the wheat flour by weight;
(2) resting the crumbly dough obtained in the step (1), and sheeting step by step to prepare into a noodle sheet;
(3) resting the noodle sheet obtained in the step (2), sheeting reversely and then cutting to obtain a noodle; and
(4) dehydrating and forming: dehydrating the noodle obtained in the step (3) to obtain the fresh noodle, wherein a dehydrating temperature is 80-100° C., and a dehydrating humidity is 70-90%.
